(19) United States
(12) Patent Application Publication
(10) Pub. No.: US 2015/0201609 A1
(43) Pub. Date: Jul. 23, 2015

(54) TEMPERATURE CONTROLLING METHOD FOR USE IN IN-VITRO FERTILIZATION (IVF)

(71) Applicant: Shivani Scientific Industries Private Limited, Mumbai (IN)

(72) Inventors: Ashish MODI, Mumbai (IN); Ravikant KALE, Mumbai (IN)

(21) Appl. No.: 14/602,098

(22) Filed: Jan. 21, 2015

(30) Foreign Application Priority Data
Jan. 22, 2014 (IN) 237/MUM/2014

(51) Int. Cl. A01N 1/02

(52) U.S. Cl. CPC A01N 1/0252

(57) ABSTRACT

Disclosed is a method for maintaining temperature of a human follicle fluid containing a human oocyte. The method may comprise a warm dry block, wherein the warm dry block may be adapted to hold a plurality of tubes. The warm dry block may further be adapted to constantly maintain the temperature of the human follicle fluid containing human oocyte in the tube. In one aspect, when the tube is displaced from the warm dry block, an outer jacket may facilitate to maintain the temperature until the tube is again placed in the warm dry block. In one aspect, the tube is wrapped around with the outer jacket, wherein the outer jacket may be composed of Aluminum (Al) or Aluminum (Al) alloy.

### PRIORITY INFORMATION

The present application takes priority from Indian Patent Application number 237/MUM/2014 filed on Jan. 22, 2014, the entirety of which is hereby incorporated by reference.

### TECHNICAL FIELD

The present disclosure described herein, in general, relates to a method for controlling and maintaining temperature of a human follicle fluid in a test tube.

### BACKGROUND

Today, demand for cryopreservation of human oocyte has been increasing as it assists reproduction clinics to perform In-vitro fertilization (IVF). The cryopreservation of human oocyte may be facilitated through a polarized light microscopy technique. The cryopreservation of the human oocyte may be extremely sensitive to cooling and temperature variations. The In-vitro fertilization (IVF) therefore may require optimal physiological conditions such as maintaining and controlling the temperature within a fixed temperature range in order to preserve cell and tissue culture. Therefore, the variation in the temperature may significantly compromise in growth of the cell. In view of this, many warming devices such as incubators, warming stages, and dry block heaters have been designed that are adapted to constantly maintain the temperature of the cell and the tissue culture. However, for routine Assisted Reproductive Technologies (ART), the temperature fluctuations can easily occur in such warming devices whenever gametes or embryos are manipulated.

### SUMMARY

Before the methods, are described, it is to be understood that this application is not limited to the particular methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to maintaining temperature of follicle fluid, contained in a test tube, in transit and the concepts are further described below in the detailed description. This summary is not intended to identify essential features of the disclosure nor is it intended for use in determining or limiting the scope of the disclosure.

In one implementation, an apparatus and a method for maintaining temperature of follicle fluid, contained in a test tube, in transit is disclosed. In order to maintain the temperature of the follicle fluid, the apparatus may comprise a warm dry block capable of holding a plurality of test tubes. It may be understood that the warm dry block is pre-heated by a heating device to maintain the temperature of the follicle fluid extracted into the test tube. After extraction of the follicle fluid, the test tube may be displaced from the warm dry block and transferred to a laboratory for In-vitro fertilization (IVF) process. In such scenario, the test tube, containing the follicle fluid, may be exposed to ambient air eventually affecting the temperature and thereby oocyte present in the follicle fluid.

In order to maintain the temperature of the follicle fluid during transition from one location to another, the warm dry block transfers heat to an outer jacket wrapped around each test tube containing the follicle fluid. The outer jacket may facilitate to maintain the temperature of the follicle fluid when the test tube along with the outer jacket is carried from one location to other. It may be understood that the outer jacket may be made up of Aluminum (Al) or Aluminum (Al) alloy which facilitates to maintain the temperature. Thus, in this manner, the outer jacket may be utilized to cover the test tube containing the follicle fluid when the follicle fluid needs to be transferred from one laboratory to the other for the IVF process.

### BRIEF DESCRIPTION OF THE DRAWINGS

The foregoing detailed description of embodiments is better understood when read in conjunction with the appended drawing. For the purpose of illustrating the disclosure, there is shown in the present document example constructions of the disclosure; however, the disclosure is not limited to the specific methods disclosed in the document and the drawing.

The detailed description is described with reference to the accompanying figure. In the figure, the left-most digit(s) of a reference number identifies the figure in which the reference number first appears. The same numbers are used throughout the drawings to refer like features and components.

FIG. 1 illustrates a warm dry block holding a plurality of test tubes is shown, in accordance with an embodiment of the present disclosure.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

In one implementation, the present disclosure discloses a method for maintaining temperature of human follicle fluid containing human oocyte for the treatment of infertility using In-Vitro Fertilization (IVF), universally known as the Test Tube Baby. As part of the treatment procedure, it is required that the human oocyte (egg) is extracted from a female patient in an operation theatre with the patient under anesthesia. In order to extract the human oocyte, a device such as vacuum generator, commonly known as ‘aspiration pump’ or ‘aspirator’ may be employed. In one aspect, the human oocyte may be extracted in a test tube. The human follicle fluid extracted in the test tube may be required to be kept under constant temperature as per the specifications of process of the infertility using In-Vitro Fertilization (IVF).

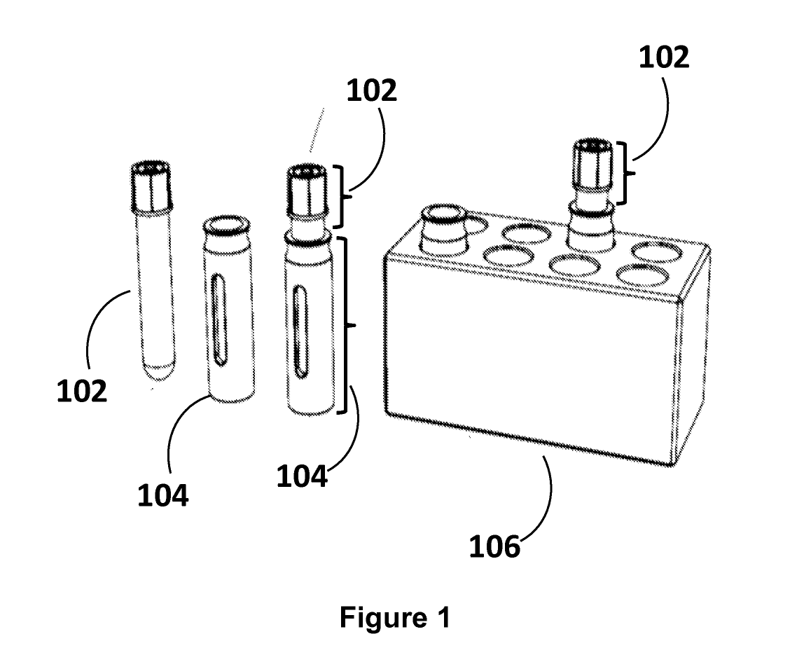

Referring to FIG. 1, an apparatus comprises a warm dry block 106 for maintaining temperature of human follicle fluid, contained in a test tube, is disclosed. It may be understood that the warm dry block 106 is capable of holding a plurality of test tubes 102-1, 102-2, 102-N, collectively referred to as a test tube 102, in a plurality of place holders. In other words, each place holder in the warm dry block 106 is capable holding a test tube 102. In order to maintain the temperature, initially, a person is engaged for holding the test tube 102 in which the human follicle fluid containing the human oocyte is extracted from the female patient. As the human follicle fluid is required to be maintained within a pre-defined temperature range, the test tube 102, containing the human follicle fluid, is kept in the place holder of the warm dry block 106. It may be understood that the temperature of the human follicle fluid is maintained by pre-heating the warm dry block 106. In one aspect, the warm dry block 106 is pre-heated by a heating device to maintain the temperature of the follicle fluid. In one aspect, the heating device may be coupled with the warm dry block 106. In one aspect, the warm dry block 106 may maintain the temperature within the pre-defined temperature range of 32° C. to 42° C.

In one embodiment, the warm dry block 106 may maintain the temperature until the test tube 102, containing the human follicle fluid, has been removed from the warm dry block 106 for further proceeding associated with In-vitro fertilization (IVF) process. Once the test tube 102 displaced from the warm dry block 106 and transferred to a laboratory for the IVF process, the test tube 102 containing the follicle fluid may be exposed to ambient air eventually affecting the temperature and thereby oocyte present in the follicle fluid.

In order to maintain the temperature of the follicle fluid during transition from one location to another, the test tube 102 may be confined with an outer jacket 104 as shown in the FIG. 1. The outer jacket 104 may enable to maintain the temperature within the pre-defined temperature range. In one aspect, the outer jacket 104 may be wrapped around the test tube 102 in order to regulate and maintain the temperature. It may be understood that the outer jacket 104 may be composed of Aluminum (Al) material. In one aspect, the outer jacket 104 may facilitate to maintain the temperature of the human follicle fluid containing the human oocyte during transition of the test tube 102 from one laboratory to another laboratory as a part of the IVF process. The outer jacket 104, in this manner, preserves the human oocyte within the pre-defined temperature. In one aspect, the outer jacket 104 may be heated using the warm dry block 106 in order to maintain the temperature. In one aspect, the test tube 102 may ensure that cells or tissue are lifted into suspension at the lowest possible speeds for promoting high cell yields by preventing cell shearing.

Although implementations for maintaining the temperature of the human follicle fluid containing human oocyte have been described in language specific to structural features and/or methods, it is to be understood that the implementations and/or embodiments are not necessarily limited to the specific features or methods described.

Exemplary embodiments discussed above may provide certain advantages. Though not required to practice aspects of the disclosure, these advantages may include those provided by the following features.

Some embodiments enable to maintain the temperature of a test tube containing the human follicle fluid within a predefined temperature range.

Some embodiments further enable to facilities an outer jacket covering the test tube that maintains the temperature of the test tube during its transit from individual labs in the clinics.

We claim:

1. An apparatus for maintaining temperature of follicle fluid, contained in a test tube, in transit, the apparatus comprising: a warm dry block capable of holding a plurality of test tubes, wherein the warm dry block is pre-heated by a heating device, and wherein the warm dry block transfers heat to an outer jacket wrapped around each test tube containing follicle fluid, and wherein the outer jacket facilitates to maintain the temperature of the follicle fluid when a test tube, of the plurality of test tubes, along with the outer jacket is carried from one location to other.

2. The apparatus of claim 1, wherein the temperature is pre-defined by the operator.

3. The apparatus of claim 1, wherein the warm dry block and the outer jacket are made up of aluminum (Al) or aluminum (Al) alloy.

4. The apparatus of claim 1, wherein the warm dry block comprises a plurality of place holders, and wherein each place holder is capable of holding the test tube.

5. A method for maintaining temperature of follicle fluid, contained in a test tube, in transit, the method comprising
placing a plurality of test tubes in a warm dry block, wherein the warm dry block is pre-heated by a heating device;
transferring heat to an outer jacket wrapped around each test tube containing follicle fluid; and
maintaining temperature of the follicle fluid when a test tube, of the plurality of test tubes, along with the outer jacket is carried from one location to other.

6. The method of claim 5, wherein the temperature is pre-defined by the operator.

7. The method of claim 6, wherein the warm dry block and the outer jacket are made up of aluminum (Al) or aluminum (Al) alloy.

8. The method of claim 6, wherein the warm dry block comprises a plurality of place holders, and wherein each place holder is capable of holding the test tube.
